(19) United States
(12) Patent Application Publication
(10) Pub. No.: US 2026/0352410 A1
(43) Pub. Date: Nov. 5, 2026

(54) TIME DOMAIN RESOURCE ALLOCATION OF DEMODULATION REFERENCE SIGNALS

(71) Applicant: Nokia Technologies Oy, Espoo (FI)

(72) Inventors: Nhat-Quang NHAN, Massy (FR); Jing Yuan SUN, Beijing (CN); Guillermo POCOVI, Aalborg (DK); Claudio ROSA, Aalborg (DK); Youngsoo YUK, Seoul (KR)

(21) Appl. No.: 19/119,332

(22) PCT Filed: Oct. 10, 2022
(86) PCT No.: PCT/CN2022/124475

§ 371 Date: Apr. 8, 2025

(51) Int. Cl. H04L 5/00; H04L 5/14; H04W 72/0446

(52) U.S. Cl. CPC H04L 5/0051; H04L 5/0094; H04L 5/14; H04W 72/0446

(57) ABSTRACT

Time domain resource allocation of demodulation reference signals is provided. An apparatus may include at least a processor and a memory storing instructions. The stored instructions and the processor may cause the apparatus to receive, from a network entity, information on slots and symbols of a transmission that may include a physical channel and a signal. The signal may include a reference signal or waveform, and the information on the slots and the symbols may include a type of slot and symbol for a unidirectional transmission and for a bidirectional transmission. The apparatus may be further caused to receive a first configuration and a second configuration of time domain resource allocation information of the signal and a waveform of the transmission to be scheduled. The apparatus may also be caused to determine time domain resource allocation of the signal and the waveform of the transmission to be scheduled.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to time domain resource allocation of demodulation reference signals.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may include an apparatus including at least one processor at least one memory. The memory may store instructions that, when executed by the at least one processor, cause the apparatus at least to receive, from a network entity, information on slots and symbols of a transmission to be scheduled comprising a physical channel and a signal. The signal may include at least one reference signal, the information on the slots and the symbols comprises at least a type of slot and symbol for unidirectional transmissions and a type of slot and symbol for bidirectional transmissions. The apparatus may also be caused to receive a first configuration and a second configuration of time domain resource allocation information of the signal and a waveform of the transmission to be scheduled. The first configuration and the second configuration may have different densities of symbols of the signal in the transmission to be scheduled or may have different waveforms of the transmission to be scheduled relative to each other. The apparatus may also be caused to determine time domain resource allocation of the signal and the waveform of the transmission to be scheduled, based on at least the information on the slots and the symbols and at least one of the first configuration and the second configuration.

Various exemplary embodiments may include an apparatus including at least one processor at least one memory. The memory may store instructions that, when executed by the at least one processor, cause the apparatus at least to provide, to a user equipment, information on slots and symbols of a transmission to be scheduled comprising a physical channel and a signal, and at least one of a first configuration and a second configuration for determining time domain resource allocation of the signal and a waveform of the transmission to be scheduled. The signal may comprise at least one reference signal. The first configuration and the second configuration may have different densities of symbols of the signal in the transmission to be scheduled or may have different waveforms of the transmission to be scheduled relative to each other, and the information on the slots and the symbols may comprise at least a type of slot and symbol for unidirectional transmissions and a type of slot and symbol for bidirectional transmissions. The apparatus may be further caused to schedule a transmission in slots and symbols associated with the signal and at least one of the first configuration and the second configuration. The apparatus may also be caused to provide, to the user equipment, the scheduling of the transmission in slots and symbols.

Certain exemplary embodiments may include a method including receiving, by an apparatus from a network entity, information on slots and symbols of a transmission to be scheduled comprising a physical channel and a signal. The signal may comprise at least one reference signal. The information on the slots and the symbols may comprise at least a type of slot and symbol for unidirectional transmissions and a type of slot and symbol for bidirectional transmissions. The method may also include receiving, by the apparatus, a first configuration and a second configuration of time domain resource allocation information of the signal and a waveform of the transmission to be scheduled. The first configuration and the second configuration may have different densities of symbols of the signal in the transmission to be scheduled or may have different waveforms of the transmission to be scheduled relative to each other. The method may also include determining, by the apparatus, time domain resource allocation of the signal and the waveform of the transmission to be scheduled, based on at least the information on the slots and the symbols and at least one of the first configuration and the second configuration.

Certain exemplary embodiments may include a method including providing, by an apparatus to a user equipment, information on slots and symbols of a transmission to be scheduled comprising a physical channel and a signal, and at least one of a first configuration and a second configuration for determining time domain resource allocation of the signal and a waveform of the transmission to be scheduled. The signal may comprise at least one reference signal. The first configuration and the second configuration may have different densities of symbols of the signal in the transmission to be scheduled or having different waveforms of the transmission to be scheduled relative to each other, and the information on the slots and the symbols comprises at least a type of slot and symbol for unidirectional transmissions and a type of slot and symbol for bidirectional transmissions. The method may further include scheduling, by the apparatus, a transmission in slots and symbols associated with the signal and at least one of the first configuration and the second configuration. The method may also include providing, by the apparatus to the user equipment, the scheduling of the transmission in slots and symbols.

Certain exemplary embodiments may include an apparatus including a first receiving means for receiving, from a network entity, information on slots and symbols of a transmission to be scheduled comprising a physical channel and a signal. The signal may comprise at least one reference signal. The information on the slots and the symbols may comprise at least a type of slot and symbol for unidirectional transmissions and a type of slot and symbol for bidirectional transmissions. The apparatus may further include a second receiving means for receiving a first configuration and a second configuration of time domain resource allocation information of the signal and a waveform of the transmission to be scheduled. The first configuration and the second configuration may have different densities of symbols of the signal in the transmission to be scheduled or may have different waveforms of the transmission to be scheduled relative to each other. The apparatus may also include a determining means for determining time domain resource allocation of the signal and the waveform of the transmission to be scheduled, based on at least the information on the slots and the symbols and at least one of the first configuration and the second configuration.

Certain exemplary embodiments may include an apparatus including a first providing means for providing, to a user equipment, information on slots and symbols of a transmission to be scheduled comprising a physical channel and a signal, and at least one of a first configuration and a second configuration for determining time domain resource allocation of the signal and a waveform of the transmission to be scheduled. The signal may comprise at least one reference signal. The first configuration and the second configuration may have different densities of symbols of the signal in the transmission to be scheduled or may have different waveforms of the transmission to be scheduled relative to each other, and the information on the slots and the symbols may include at least a type of slot and symbol for unidirectional transmissions and a type of slot and symbol for bidirectional transmissions. The apparatus may also include a scheduling means for scheduling a transmission in slots and symbols associated with the signal and at least one of the first configuration and the second configuration. The apparatus may further include a second providing means for providing, to the user equipment, the scheduling of the transmission in slots and symbols.

Various exemplary embodiments may include a non-transitory computer readable storage medium storing instructions that, when executed by an apparatus, causes the apparatus to perform at least one of the methods described herein.

Various exemplary embodiments may include a computer program including instructions that, when executed by an apparatus, causes the apparatus to perform at least one of the methods described herein.

Certain exemplary embodiments may include circuitry configured to perform at least one of the methods described herein.

### BRIEF DESCRIPTION OF THE DRAWINGS

For proper understanding of example embodiments, reference should be made to the accompanying drawings, as follows:

FIG. 1 illustrates an example of frequency-time resource partitioning with subband non-overlapping full duplex, time division duplex, and frequency division duplex;

FIG. 2 illustrates an example of slots for subband non-overlapping full duplex and slots for non-subband non-overlapping full duplex;

FIG. 3 illustrates an example of co-channel interference during deployment of subband non-overlapping full duplex;

FIG. 4 illustrates an exemplary signal diagram according to various exemplary embodiments;

FIG. 5 illustrates an example of a flow diagram of a method according to various exemplary embodiments;

FIG. 6 illustrates another example of a flow diagram of a method according to some exemplary embodiments; and

FIG. 7 illustrates a set of apparatuses according to some exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and non-transitory computer program products for time domain resource allocation of demodulation reference signals. For instance, certain exemplary embodiments may be directed to time domain resource allocation of demodulation reference signals in sub-band full duplex operation.

In NR, communications may be governed, at least in part, by physical layer control signaling of uplink (UL) and downlink (DL) transport channels, such as physical downlink shared channels (PDSCH) and physical uplink shared channels (PUSCH). The resources allocated for PDSCH and PUSCH may be within a bandwidth part (BWP) of a carrier. The resources in the time domain for PDSCH and PUSCH transmissions may be scheduled by a downlink control information (DCI) format.

As described in the technical specifications of 3^{rd} Generation Partnership Project (3GPP), for PDSCH transmissions, the time domain resource allocation for the PDSCH may be determined by a starting symbol index S in a slot and a length L in unit of symbols. Based on S and L, two PDSCH mapping types may be defined depending on whether a normal cyclic prefix or an extended cyclic prefix is applied for orthogonal frequency division multiplexing (OFDM). For example, for normal cyclic prefix OFDM, a first mapping type, which may be referred to as mapping type A, may define S as any value from 0 to 3 and may define a minimum value of L as 3. As another example, a second mapping type, which may be referred to as mapping type B, may define S as any value from 0 to 12 and may define L as any value from 2 to 13.

For PUSCH transmissions, similar to PDSCH transmissions, 3GPP describes two PUSCH mapping types may be defined based on the S and L, and whether a normal cyclic prefix or an extended cyclic prefix is applied for OFDM. For example, for normal cyclic prefix OFDM, a first mapping type, which may be referred to as mapping type A, may define S as always 0, and may define the minimum value of L as 4. As another example, a second mapping type, which may be referred to as mapping type B, may define S as any value from 0 to 13 and may define L as any value from 1 to 14.

According to 3GPP, when establishing a PDSCH and/or a PUSCH, a demodulation reference signal (DM-RS) may be used for channel estimation as part of demodulation. For PDSCH, each position of one or more reference symbols of the DM-RS, which may be referred to as DM-RS symbols l̅, in a PDSCH may be defined in 3GPP for different PDSCH durations l̅_{d}. Further, OFDM symbol index l for DM-RS position determination may be set relative to a start of each PDSCH.

For example, the position l₀ of a first DM-RS symbol for PDSCH mapping type A may be defined by a higher-layer parameter (e.g., dmrs-TypeA-Position), and l₀=0 for a second DM-RS symbol for PDSCH mapping type B. Additionally, a radio resource control (RRC) parameter dmrs-AdditionalPosition in DMRS-DownlinkConfig may be used to configure whether one or more additional DM-RS may be needed.

A reference point position of the OFDM symbol index l and the position l₀ of the first DM-RS symbol may be based on the mapping type, such as mapping type A or mapping type B discussed above. As an example for PDSCH mapping type A, l may be defined relative to the start of the slot, and l₀=3 may be defined when the higher-layer parameter, such as dmrs-TypeA-Position, indicates a position set to be equal to 3. When the position indicated by the higher-layer parameter, such as dmrs-TypeA-Position, is not equal to 3, l₀=2. In this example, l_{d} may define the duration between the first OFDM symbol of the slot and the last OFDM symbol of the scheduled PDSCH resources in the slot.

This example, which is based on 3GPP for PDSCH mapping type A, may further define that dmrs-AdditionalPosition may be equal to position “pos3” only when dmrs-TypeA-Position is equal to position “pos2.” The duration between the first OFDM symbol and the last OFDM symbol may be set as l_{d}=3 and l_{d}=4 symbols when dmrs-TypeA-Position is equal to position “pos2.” For single-symbol DM-RS, l₁=11 unless the higher-layer parameter lte-CRS-ToMatchAround, Ite-CRS-PatternList1, or lte-CRS-PatternList2 is configured, the higher-layer parameter dmrs-AdditionalPosition is equal to ‘pos1’ and l₀=3, and the UE indicates the capability for additionalDMRS-DL-Alt. When these conditions are met, l₁=12.

As an example for PDSCH mapping type B, l may be defined relative to the start of scheduled PDSCH resources and l₀=2. In this example, l_{d} may be the duration of the scheduled PDSCH resources and may be used for the UE to determine if or when an additional one or more DM-RS symbols will be received by the UE. When the PDSCH duration l_{d} is ∈ {2, 3, 4, 5, 6, 7, 8, 9, 10, 11, 12, 13} OFDM symbols for normal cyclic prefix or l_{d} ∈ {2, 4, 6} OFDM symbols for extended cyclic prefix, and a front-loaded DM-RS of the PDSCH allocation collides with resources reserved for a search space set associated with a CORESET, l̅ may be incremented such that the first DM-RS symbol occurs immediately after the CORESET and until no collision with any CORESET occurs.

Further, if the PDSCH duration l_{d} is 2 symbols, the UE may not be expected to receive a DM-RS symbol beyond the second symbol. As another example, if the PDSCH duration l_{d} is 5 symbols and if one additional single-symbol DMRS is configured, the UE may expect the additional DM-RS to be transmitted on the 5th symbol when the front-loaded DM-RS symbol is in the 1st symbol of the PDSCH duration. Otherwise, the UE may expect that the additional DM-RS is not transmitted.

As a further example, when the PDSCH duration l_{d} may be 7 symbols for normal cyclic prefix or 6 symbols for extended cyclic prefix and one additional single-symbol DM-RS is configured, the UE may expect the additional DM-RS to be transmitted on the 5th or 6th symbol when the front-loaded DM-RS symbol is in the 1st or 2nd symbol, respectively, of the PDSCH duration. Otherwise, the UE may expect that the additional DM-RS is not transmitted.

Some additional examples of PDSCH duration may include when the PDSCH duration l_{d} ∈ {5, 6, 7, 8, 9, 10 ,11, 12 ,13} OFDM symbols, the UE may not expect to receive the front-loaded DM-RS beyond the 4th symbol. If the PDSCH duration l_{d} is 12 or 13 symbols, the UE may not expect to receive DM-RS mapped to symbol 12 or later in the slot. For all values of the PDSCH duration l_{d} other than 2, 5, and 7 symbols, the UE may not expect to receive DM-RS beyond the (l_{d}-1):th symbol. If the PDSCH duration l_{d} is less than or equal to 4 OFDM symbols, only single-symbol DM-RS may be supported. If the higher-layer parameter lte-CRS-ToMatchAround, lte-CRS-PatternList1, or lte-CRS-PatternList2 is configured, where the PDSCH duration l_{d}=10 symbols for normal cyclic prefix, a subcarrier spacing configuration μ=0, a single-symbol DM-RS is configured, and at least one PDSCH DM-RS symbol in the PDSCH allocation collides with a symbol containing resource elements as indicated by the higher-layer parameter lte-CRS-ToMatchAround, lte-CRS-PatternList1, or Ite-CRS-PatternList2, then l̅ may be incremented by one in all slots.

PUSCH may be similarly configured as PDSCH, as discussed above. In PUSCH, a position of one or more DM-Rs symbols l̅ in the PUSCH may be defined according to 3GPP for different PUSCH duration l_{d}. The OFDM symbol index l for DM-RS position determination may be relative to the start of each PUSCH. The position l₀ of the first DM-RS symbol in, for example a PUSCH mapping type A, may be defined by the higher-layer parameter dmrs-TypeA-Position, and l₀=0 may be defined for another example, such as PUSCH mapping type B. The RRC parameter dmrs-AdditionalPosition in DMRS-UplinkConfig may be used to configure whether additional DM-RS is needed. For a PUSCH repetition type A, the DM-RS positions per slot may be the same across repetitions.

Similar to PDSCH, in PUSCH a reference point of the OFDM symbol index l and the position l₀ of the first DM-RS symbol may be based on the mapping type, such as mapping type A or mapping type B discussed above. As an example for PUSCH mapping type A, I may be defined relative to the start of the slot if frequency hopping is disabled and relative to the start of each hop in case frequency hopping is enabled. l₀=3 may be defined by the higher-layer parameter, such as dmrs-TypeA-Position.

In another example for mapping type B, I may be defined relative to the start of the scheduled PUSCH resources if frequency hopping is disabled and relative to the start of each hop in case frequency hopping is enabled, and l₀=0 may be set.

Similar to PDSCH, for PUSCH each position of DM-RS symbols l̅ may be based, for example, on the PUSCH durations l_{d}. Some examples of PUSCH duration may include when intra-slot frequency hopping is not used, l_{d} may be the duration between the first OFDM symbol of the slot and the last OFDM symbol of the scheduled PUSCH resources in the slot for PUSCH mapping type A. Alternatively, if intra-slot frequency hopping is not used, l_{d} is the duration of scheduled PUSCH resources for PUSCH mapping type B. As a further alternative, if intra-slot frequency hopping is not used, l_{d} is the duration per hop.

Further, if the higher-layer parameter maxLength in DMRS-UplinkConfig is not configured, or for a msgA transmission msgA-MaxLength in msgA-DMRS-Config is not configured, a single-symbol DM-RS may be used. If the higher-layer parameter maxLength in DMRS-UplinkConfig is equal to ‘len2’, the associated downlink control information (DCI) or configured grant configuration may be used to determine whether single-symbol or double-symbol DM-RS may be used. If the higher-layer parameter msgA-MaxLength in msgA-DMRS-Config is equal to ‘len2’, a double-symbol DM-RS may be used. If the higher-layer parameter dmrs-AdditionalPosition is not set to ‘pos0’ and intra-slot frequency hopping is by the higher layer, 3GPP standards may be used assuming dmrs-AdditionalPosition is equal to ‘pos1’ for each hop. For PUSCH mapping type A, dmrs-AdditionalPosition may be equal to position “pos3” only when dmrs-TypeA-Position is equal to position “pos2.” The duration between the first OFDM symbol and the last OFDM symbol may be set as l_{d}=4 symbols when dmrs-TypeA-Position is equal to position “pos2.”

In order to facilitate transmission, modulated symbols and/or reference signals may be converted to a waveform, which is a baseband signal, before the baseband signal is mixed to a radio frequency (RF) and transmitted. The waveform may be cyclic prefix orthogonal frequency division multiplexing (CP-OFDM), which may be applicable to both uplink and downlink, or discrete Fourier transform spread orthogonal frequency division multiplexing (DFT-s-OFDM), which may be applicable to only uplink. DFT-s-OFDM may only support a single transmission layer (rank=1) per user and CP-OFDM may support more than one layer (rank≥1). This may allow CP-OFDM to provide a higher throughput and capacity than DFT-s-OFDM. In contrast, DFT-s-OFDM may have a relatively lower peak-to-average power ratio (PAPR), which may allow DFT-s-OFDM to be used with a higher transmit power to provide relatively improved coverage.

DFT-s-OFDM may be generated by adding a transform precoding block before the processing blocks used for generating CP-OFDM. The transform precoding block may be a fast Fourier transform (FFT) block that converts a time domain signal into frequency domain signal. Due to the transform precoding block used in the transmitter, the waveform may be separately configured so that a receiver can perform an inverse operation (IFFT).

PUSCH and PDSCH transmissions may be separated by duplexing in time and/or frequency. A time division duplex (TDD) may allow the uplink, PUSCH, and downlink, PDSCH, transmissions to use the same carrier frequency and are separated only by time. A frequency division duplex (FDD) may allow uplink, PUSCH, and downlink, PDSCH, transmissions to use different frequencies and occur at substantially the same time, such as simultaneously or substantially simultaneously.

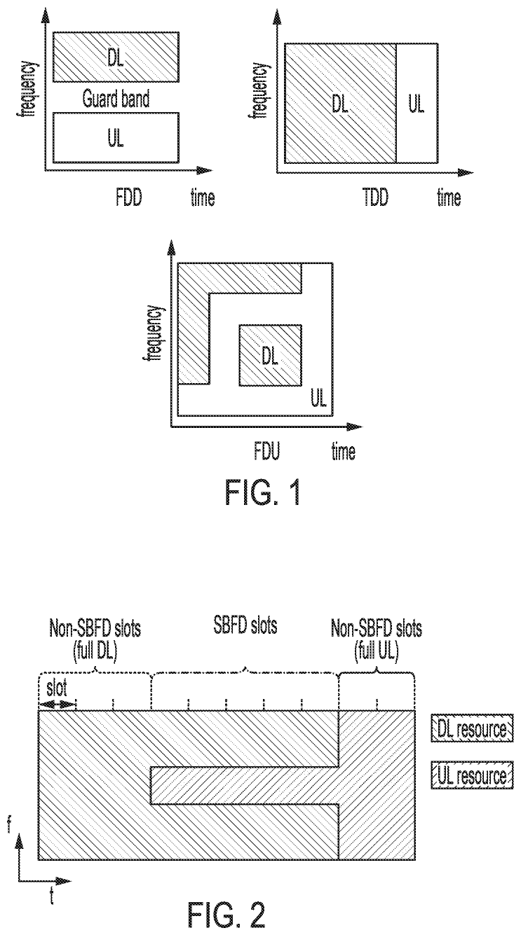

It may be beneficial to allow simultaneous DL and UL transmission on different physical resource blocks (PRBs), which may be referred to as subbands, within an unpaired wideband NR cell. This may be referred to as subband non-overlapping full duplex (SBFD). For example, FIG. 1 illustrates an example of frequency-time resource partitioning with SBFD as compared to FDD and TDD.

FIG. 2 illustrates an example of slots of the SBFD that may be defined for both non-overlapping DL subbands and UL subbands, and slots of non-SBFD that may be defined such that the entire band may be used for DL or UL, such as, for example, legacy or full DL/UL slots. The slots of the SBFD may be known by the UE, which may be referred to as an SBFD-aware UE.

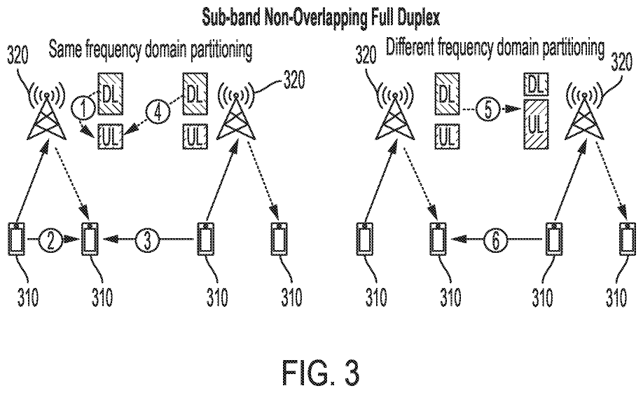

FIG. 3 illustrates an example of co-channel interference in deployment of SBFD. SBFD may provide cross-link interference (CLI), such as co-channel inter-subband CLI and co-channel intra-subband CLI. Co-channel inter-subband CLI may be classified as base station, such as gNB, interference, intra-cell UE-to-UE co-channel inter-subband CLI, inter-cell UE-to-UE co-channel inter-subband CLI, and/or gNB-to-gNB co-channel inter-subband CLI. Co-channel intra-subband CLI may be classified as gNB-to-gNB inter-cell co-channel intra-subband CLI and/or UE-to-UE inter-cell co-channel intra-subband CLI.

As shown in FIG. 3, UEs 310 may be subject to co-channel interference when performing UL and DL transmissions with a network entity 320, for example a gNB, another UE, and the like. As examples of UL transmissions in one or more slots of SBFD shown in FIG. 3, interference “1” may be gNB self-interference, interference “4” may be gNB-to-gNB co-channel inter-subband CLI, and interference “5” may be gNB-to-gNB inter-cell co-channel intra-subband CLI. As examples of DL transmissions in SBFD slots shown in FIG. 3, interference “2” may be intra-cell UE-to-UE co-channel inter-subband CLI, interference “3” may be inter-cell UE-to-UE co-channel inter-subband CLI, and interference “6” may be UE-to-UE inter-cell co-channel intra-subband CLI.

To reduce the CLI in slots for SBFD discussed above, one or more additional DM-RS symbol may be added in PDSCH/PUSCH transmissions in slots of SBFD compared to slots of non-SBFD. Adding the one or more additional DM-RS symbol may improve the performance of the transmission in slots of SBFD via improved channel estimation. In addition, or alternatively, a lower power-to-average ratio (PAPR) waveform for PUSCH transmissions in slots of SBFD, for example DFT-s-OFDM, as compared to slot of non-SBFD, for example OFDM. The lower PAPR may improve the performance of the transmission in slots of SBFD by enabling UE to use a maximum transmit power of the UE. Therefore,

As discussed in detail below, various exemplary embodiments may provide several technical improvements, enhancements, and/or advantages including, for example, providing a framework for indicating and determining different DM-RS symbol allocation and/or different waveforms for the transmissions on SBFD and non-SBFD slots.

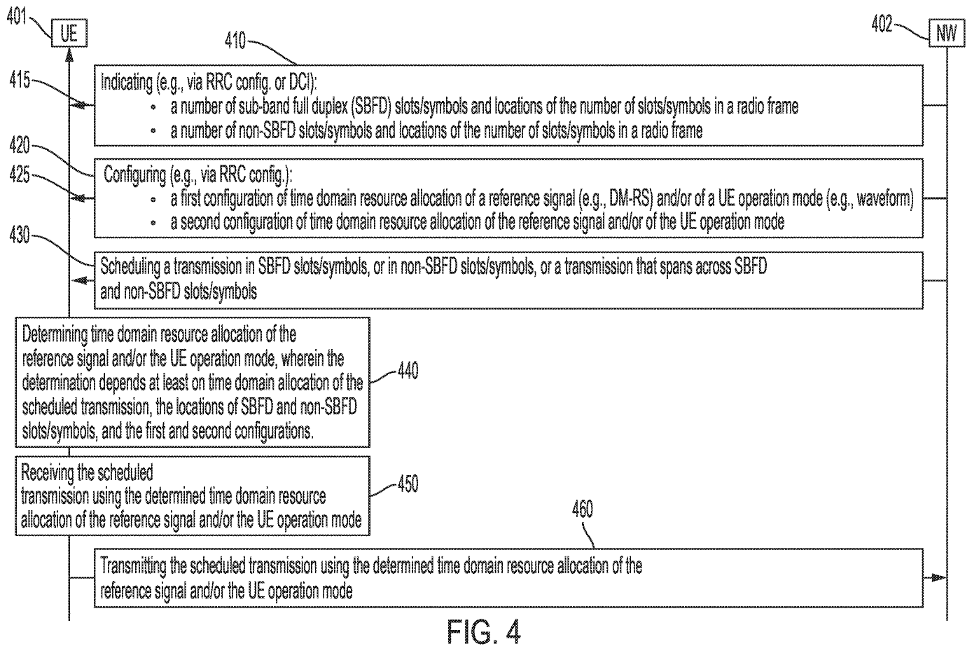

FIG. 4 illustrates an exemplary signal diagram according to various exemplary embodiments. In particular, FIG. 4 illustrates an exemplary signal diagram for a UE 401 and a network entity (NW) 402, such as a gNB, to determine one or more different DM-RS symbols allocations and/or different waveforms for the transmissions on SBFD slots and non-SBFD slots.

At 410, the NW 402 may indicate and provide (i) a frequency band, (ii) a number of slots/symbols in which the frequency band is split into multiple subbands, such as SBFD slots/symbols and locations of the number of slots/symbols in a radio frame, and (iii) a number of slots/symbols in which the entire frequency band may be used for DL transmissions or UL transmissions, such as non-SBFD slots/symbols, and locations of the number of slots/symbols in a radio frame. The frequency band may be split into multiple subbands, and may include at least one subband for DL transmissions and at least one subband for UL transmissions.

At 415, the UE 401 may receive, from the NW 402, the frequency band, the number of slots/symbols in which the frequency band is split into multiple subbands, and the number of slots/symbols in which the entire frequency band may be used for DL transmissions or UL transmissions, as indicated by the NW 402.

At 420, the NW 402 may indicate and provide a first configuration and a second configuration of time domain resource allocation of a reference signal, for example, a DM-RS, and/or of a UE operation mode, for example a waveform. The second configuration may be used for transmissions in SBFD slots/symbols. For example, the second configuration of time domain resource allocation of DM-RS may require the UE 401 to transmit UL transmissions, such as PUSCH, or receive DL transmissions, such as PDSCH, in SBFD slots/symbols with a higher number of DM-RS symbols than when the first configuration is used. In another example, the second configuration of the UE operation mode (i.e., one or more waveforms) may require the UE 401 to transmit UL transmissions (e.g., PUSCH) in SBFD slots/symbols with a waveform that is more robust against interfered channels (e.g., DFT-s-OFDM) as compared to the first configuration. The first configuration may require the UE 401 to transmit with another waveform, such as CP-OFDM.

At 425, the UE 401 may receive, from the NW 402, the first configuration and the second configuration.

At 430, the NW 402 may schedule a transmission. According to certain exemplary embodiments, the transmission may be on SBFD slots/symbols, or on non-SBFD slots/symbols, or may span across SBFD and non-SBFD slots/symbols. For example, the transmission on SBFD slots/symbols or on non-SBFD slots/symbols may be a PDSCH or a PUSCH with or without repetitions. In another example embodiment, the transmission that spans across SBFD and non-SBFD slots/symbols may be a PDSCH or a PUSCH with repetitions.

At 440, the UE 401 may determine time domain resource allocation of the reference signal and/or the UE operation mode. According to certain exemplary embodiments, the determination by the UE 401 may be based on at least time domain allocation of the scheduled transmission, the locations of SBFD and non-SBFD slots/symbols, and the first configuration and the second configuration.

In a first example, when the transmission is scheduled entirely on the non-SBFD slots/symbols, time domain resource allocation of the reference signal and/or the UE operation mode to be applied for the transmission may be based on the first configuration. When the transmission is scheduled entirely on the SBFD slots/symbols, time domain resource allocation of the reference signal and/or the UE operation mode to be applied for the transmission may be based on the second configuration. When the transmission spans across SBFD and non-SBFD slots/symbols, time domain resource allocation of the reference signal and/or the UE operation mode may be based on the first configuration for the portion of the transmission that overlaps with non-SBFD slots/symbols, and the second configuration for the portion of the transmission that overlaps with SBFD slots/symbols.

In a second example, the determination of the time domain resource allocation may be based on the first configuration. When the transmission is scheduled entirely on the non-SBFD slots/symbols, time domain resource allocation of the reference signal and/or the UE operation mode to be applied for the transmission may be based on the first configuration. When the transmission is scheduled entirely on the SBFD slots/symbols, time domain resource allocation of the reference signal and/or the UE operation mode may be based on the first configuration scaled by at least one offset value.

As an example in time domain resource allocation of the reference signal, candidate values of dmrs-AdditionalPosition may be defined as “pos0 ,” “pos1,” “pos2,” and/or “pos3.” Assuming that the first configuration may be configured as “pos0” for dmrs-AdditionalPosition, and assuming that the offset value is 2, the UE 401 may determine the allocation of one or more DM-RS symbols. For instance, the determination may be made by applying the offset value on the index of the candidate values for dmrs-AdditionalPosition, such as dmrs-AdditionalPosition may have a value “pos2” for determining one or more DM-RS symbol locations for the transmission. Another example in time domain resource allocation of the reference signal assumes that the first configuration may be configured as “pos0” for dmrs-AdditionalPosition, and assumes that the offset value may be set to 4. In this example, the UE 401 may determine the allocation of one or more DM-RS symbols by using dmrs-AdditionalPosition=pos0, and apply the offset value in unit of symbol and with reference to the first or the last DM-RS symbol location as determined. Thus, at least one symbol in the transmission may be determined in which at least one additional DM-RS symbol may be allocated.

An example in time domain resource allocation of the UE operation mode may assume candidate waveforms for the transmissions may be configured, or specified, as a list. For example, {CP-OFDM}, {DFT-s-OFDM} {DFT-s-OFDM with frequency domain spectrum shaping (FDSS)}, {DFT-s-OFDM with FDSS and spectrum extension}. This example in time domain resource allocation of the UE operation mode may also assume that the first configuration may be configured for CP-OFDM, such as associating to index 0 in the list, and assume that the offset value is 2. In some exemplary embodiments, the UE 401 may determine the waveform for the transmission by applying the offset value on the index of waveform candidates, for example {DFT-s-OFDM with FDSS} .

Further continuing the second example discussed above, when the transmission spans across SBFD and non-SBFD slots/symbols, time domain resource allocation of the reference signal and/or the UE operation mode may be based on the first configuration for the portion of the transmission that overlaps with non-SBFD slots/symbols, and based on the first configuration scaled by the at least one offset value for the portion of the transmission that overlaps with SBFD slots/symbols.

At 450, when the transmission is a downlink transmission, such as a PDSCH, the UE 401 may receive the transmission on the non-SBFD slots/symbols and/or on the SBFD slots/symbols scheduled by the NW 402 at 430. The UE 401 may receive the scheduled transmission using the determined time domain resource allocation of the reference signal and/or the UE operation mode.

At 460, when the transmission is an uplink transmission, such as a PUSCH, the UE 401 may transmit the scheduled transmission on the non-SBFD slots/symbols and/or on the SBFD slots/symbols to the NW 402 based on the determined time domain resource allocation of the reference signal and/or the UE operation mode.

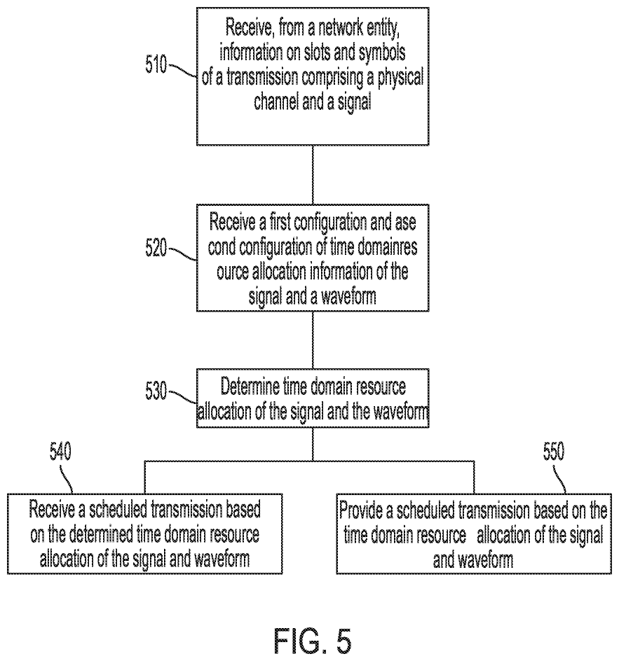

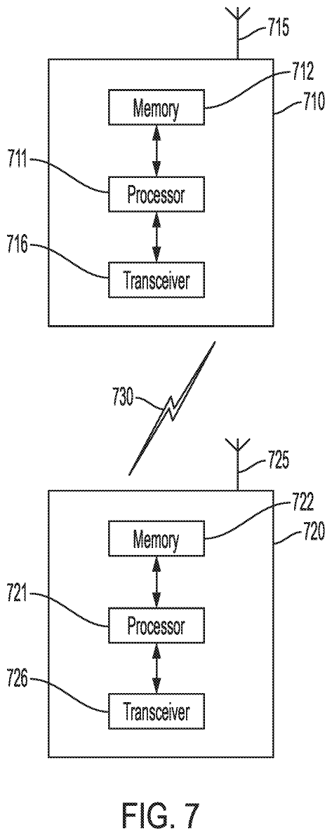

FIG. 5 illustrates an example flow diagram of a method, according to various exemplary embodiments. In the exemplary embodiments, the method of FIG. 5 may be performed by a network element, or a group of multiple network elements in a 3GPP system, such as LTE or 5G-NR. For instance, in the exemplary embodiments, the method of FIG. 5 may be performed by a UE similar to apparatus 710 illustrated in FIG. 7.

According to various exemplary embodiments, the method of FIG. 5 may include, at 510, receiving, by an apparatus from a network entity, information on slots and symbols of a transmission to be scheduled comprising a physical channel and a signal. The signal may include at least one reference signal. The information on the slots and the symbols may include at least a type of slot and symbol for unidirectional transmissions and a type of slot and symbol for bidirectional transmissions. At 520, the method may include receiving, by the apparatus, a first configuration and a second configuration of time domain resource allocation information of the signal and a waveform of the transmission to be scheduled. The first configuration and the second configuration may have different densities of symbols of the signal in the transmission to be scheduled or may have different waveforms of the transmission to be scheduled relative to each other. At 530, the method may include determining, by the apparatus, time domain resource allocation of the signal and the waveform of the transmission to be scheduled, based on at least the information on the slots and the symbols and at least one of the first configuration and the second configuration.

According to some exemplary embodiments, the slots and the symbols may be at least one of sub-band full duplex and/or non-sub-band full duplex.

According to certain exemplary embodiments, the time domain resource allocation of the signal and the waveform of the transmission to be scheduled may be determined based on the first configuration when the slots and the symbols are sub-band full duplex.

According to certain exemplary embodiments, the time domain resource allocation of the signal and the waveform of the transmission to be scheduled may be determined based on the first configuration when the slots and the symbols are non-sub-band full duplex. Further, the time domain resource allocation of the signal and the waveform of the transmission to be scheduled may be determined based on the second configuration when the slots and the symbols are sub-band full duplex.

According to some exemplary embodiments, the time domain resource allocation of the signal and the waveform of the transmission to be scheduled may be determined based on both the first configuration and the second configuration when the slots and the symbols comprise sub-band full duplex and non-sub-band full duplex.

According to various exemplary embodiments, at 540, the method may be further include receiving, by the apparatus from the network entity, a scheduled transmission based on the determined time domain resource allocation of the signal and the waveform of the transmission to be scheduled, as similarly shown in FIG. 4.

According to various exemplary embodiments, at 550, the method may be further include providing, by the apparatus to the network entity, a scheduled transmission based on the determined time domain resource allocation of this signal and the waveform of the transmission to be scheduled, as similarly shown in FIG. 4.

According to certain exemplary embodiments, the signal may be a demodulation reference signal. Further, the demodulation reference signal may include one of either a first demodulation reference signal when the slots and the symbols are sub-band full duplex, and a second demodulation reference signal when the slots and the symbols are non-sub-band full duplex. The first demodulation reference signal may be different than the second demodulation reference signal.

According to certain exemplary embodiments, the first configuration and the second configuration may have different densities of symbols of the signal in the transmission to be scheduled and may have different waveforms of the transmission to be scheduled relative to each other

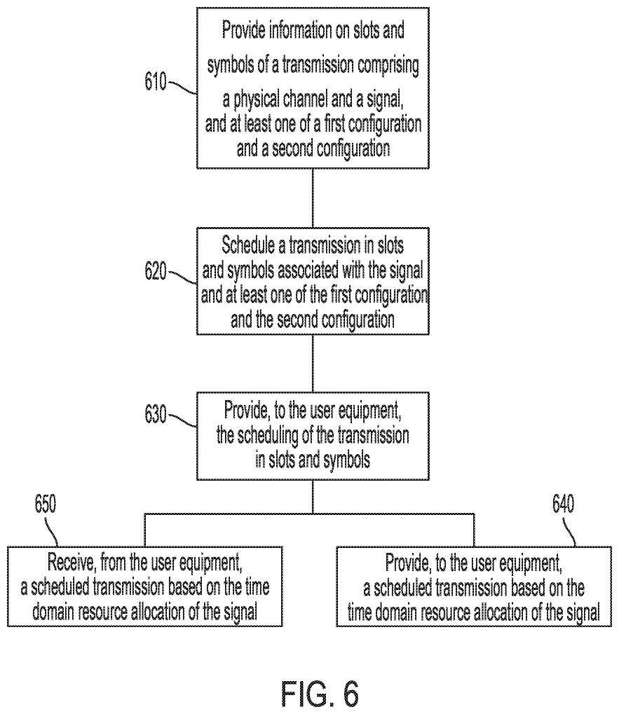

FIG. 6 illustrates an example flow diagram of a method, according to certain example embodiments. In an example embodiment, the method of FIG. 6 may be performed by a network element, or a group of multiple network elements in a 3GPP system, such as LTE or 5G-NR. For instance, in an example embodiment, the method of FIG. 6 may be performed by an NW similar to apparatus 720 illustrated in FIG. 7.

According to various exemplary embodiments, the method of FIG. 6 may include, at 610, providing, by an apparatus to a user equipment, information on slots and symbols of a transmission to be scheduled comprising a physical channel and a signal, and at least one of a first configuration and a second configuration for determining time domain resource allocation of the signal and a waveform of the transmission to be scheduled. The signal may include at least one reference signal. The first configuration and the second configuration may have different densities of symbols of the signal in the transmission to be scheduled or may have different waveforms of the transmission to be scheduled relative to each other. The information on the slots and the symbols may include at least a type of slot and symbol for unidirectional transmissions and a type of slot and symbol for bidirectional transmissions. At 620, the method may further include scheduling a transmission in slots and symbols associated with the signal and at least one of the first configuration and the second configuration. At 630, the method may include providing, to the user equipment, the scheduling of the transmission in slots and symbols.

According to some exemplary embodiments, the slots and the symbols may be at least one of sub-band full duplex and/or non-sub-band full duplex.

According to some exemplary embodiments, the time domain resource allocation of the signal and the waveform of the transmission to be scheduled may be determined based on the first configuration when the slots and the symbols are sub-band full duplex.

According to some exemplary embodiments, the scheduling of the transmission may be provided based on the first configuration when the slots and the symbols are non-sub-band full duplex. Further, the scheduling of the transmission may be provided based on the second configuration when the slots and the symbols are sub-band full duplex.

According to certain exemplary embodiments, the scheduling of the transmission may be provided based on both the first configuration and the second configuration when the slots and the symbols comprise sub-band full duplex and non-sub-band full duplex.

According to various exemplary embodiments, at 640, the method may be further include providing a scheduled transmission based on the time domain resource allocation of the signal and the waveform of the transmission to be scheduled, as similarly shown in FIG. 4.

According to various exemplary embodiments, at 650, the method may be further include receiving a scheduled transmission based on the time domain resource allocation of the signal and the waveform of the transmission to be scheduled, as similarly shown in FIG. 4.

According to some exemplary embodiments, the signal may be a demodulation reference signal. The demodulation reference signal may include one of either a first demodulation reference signal when the slots and the symbols are sub-band full duplex, and a second demodulation reference signal when the slots and the symbols are non-sub-band full duplex. The first demodulation reference signal may be different than the second demodulation reference signal.

According to certain exemplary embodiments, the first configuration and the second configuration may have different densities of symbols of the signal in the transmission to be scheduled and may have different waveforms of the transmission to be scheduled relative to each other.

FIG. 7 illustrates a set of apparatuses 710 and 720 according to various exemplary embodiments. In the various exemplary embodiments, the apparatus 710 may be an element in a communications network or associated with such a network, such as a UE, RedCap UE, SL UE, mobile equipment (ME), mobile station, mobile device, stationary device, IoT device, or other device. UE 401 may an example of apparatus 710 according to various exemplary embodiments as discussed above. It should be noted that one of ordinary skill in the art would understand that apparatus 710 may include components or features not shown in FIG. 7. In addition, apparatus 720 may be a network, core network element, or element in a communications network or associated with such a network, such as a base station, an NE, an NW, or a gNB. For example, NW 402 may be an example of apparatus 720 according to various exemplary embodiments as discussed above. It should be noted that one of ordinary skill in the art would understand that apparatus 720 may include components or features not shown in FIG. 7.

According to various exemplary embodiments, the apparatus 710 may include at least one processor 711, and at least one memory 712, as shown in FIG. 7. The memory 712 may store instructions that, when executed by the processor 711, cause the apparatus 710 to perform the method as discussed above with respect to FIG. 5.

According to various exemplary embodiments, the apparatus 720 may include at least one processor 721, and at least one memory 722, as shown in FIG. 7. The memory 722 may store instructions that, when executed by the processor 721, cause the apparatus 720 to perform the method discussed above with respect to FIG. 6.

In some example embodiments, an apparatus (for example, apparatuses 710 and/or 720) may include means for performing a method, a process, or any of the variants discussed herein. Examples of the means may include one or more processors, memory, controllers, transmitters, receivers, and/or computer program code for causing the performance of the operations.

According to some exemplary embodiments, the apparatus (for example, apparatuses 710) may include at least one processor and at least one memory. The memory may store instructions that, when executed by the at least one processor, cause the apparatus at least to receive, from a network entity similar to apparatus 720, information on slots and symbols in a signal for transmission. The apparatus may further be caused to receive a first configuration and a second configuration of time domain resource allocation information of the signal. The apparatus may also be caused to determine time domain resource allocation information of the signal based on at least a time domain resource allocation of a scheduled transmission, the information on the slots and the symbols, and at least one of the first configuration and the second configuration.

According to some exemplary embodiments, the apparatus (for example, apparatuses 720) may include at least one processor, and at least one memory. The memory may store instructions that, when executed by the at least one processor, cause the apparatus at least to provide, to a user equipment similar to apparatus 710, information on slots and symbols in a signal for transmission, and at least one of a first configuration and a second configuration for determining time domain resource allocation information of the signal. The apparatus may be further caused to schedule a transmission in slots and symbols associated with the signal, and to provide, to the user equipment similar to apparatus 710, the scheduled transmission.

Various exemplary embodiments described above may provide several technical improvements, enhancements, and/or advantages. For instance, in some exemplary embodiments, it may be possible to enhance the performance, for example reliability, of the transmissions in SBFD slots/symbols by using additional DM-RS symbols or by using a lower PAPR waveform, such as DFT-s-OFDM. By using one or more additional DM-RS symbols for transmissions in SBFD slots/symbols, various exemplary embodiments may improve a channel estimation/frequency offset estimation to overcome CLI, and/or improve the signal-to-noise ratio (SNR) due to the improved channel estimation.

Certain exemplary embodiments further provide advantages by using DFT-s-OFDM waveform for transmissions on SBFD slots/symbols, such as providing additional capacity to UL power boosting due to lower PAPR compared to a CP-OFDM counterpart. This may be useful when a UE is suffering from UL power limiting, and may be able to provide up to 1 dB gain. Some exemplary embodiments may also provide a lower throughput due to the maximum number of multiple-input multiple-output (MIMO) layers (rank) supported by DFT-s-OFDM, which may be set as 1. This allows switching back to CP-OFDM to support higher rank in non-SBFD slots/symbols, which provides improved throughput.

In some example embodiments, apparatuses 710 and/or 720 may include one or more processors, one or more computer-readable storage medium (for example, memory, storage, or the like), one or more radio access components (for example, a modem, a transceiver, or the like), and/or a user interface. In some example embodiments, apparatuses 710 and/or 720 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 7, apparatuses 710 and/or 720 may include or be coupled to processors 711 and 721, respectively, for processing information and executing instructions or operations. Processors 711 and 721 may be any type of general or specific purpose processor. In fact, processors 711 and 721 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 711 (and 721) for each of apparatuses 710 and/or 720 is shown in FIG. 7, multiple processors may be utilized according to other example embodiments. For example, it should be understood that, in certain example embodiments, apparatuses 710 and/or 720 may include two or more processors that may form a multiprocessor system (for example, in this case processors 711 and 721 may represent a multiprocessor) that may support multiprocessing. According to certain example embodiments, the multiprocessor system may be tightly coupled or loosely coupled to, for example, form a computer cluster).

Processors 711 and 721 may perform functions associated with the operation of apparatuses 710 and/or 720, respectively, including, as some examples, precoding of antenna gain/phase parameters, encoding and decoding of individual bits forming a communication message, formatting of information, and overall control of the apparatuses 710 and/or 720, including processes illustrated in FIGS. 4-6.

Apparatuses 710 and/or 720 may further include or be coupled to memory 712 and/or 722 (internal or external), respectively, which may be coupled to processors 711 and 721, respectively, for storing information and instructions that may be executed by processors 711 and 721. Memory 712 (and memory 722) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 712 (and memory 722) can be comprised of any combination of random access memory (RAM), read only memory (ROM), static storage such as a magnetic or optical disk, hard disk drive (HDD), or any other type of non-transitory machine or computer readable media. The instructions stored in memory 712 and memory 722 may include program instructions or computer program code that, when executed by processors 711 and 721, enable the apparatuses 710 and/or 720 to perform tasks as described herein.

In certain example embodiments, apparatuses 710 and/or 720 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 711 and 721 and/or apparatuses 710 and/or 720 to perform any of the methods illustrated in FIGS. 4-6.

In some exemplary embodiments, apparatuses 710 and/or 720 may also include or be coupled to one or more antennas 715 and 725, respectively, for receiving a downlink signal and for transmitting via an uplink from apparatuses 710 and/or 720. Apparatuses 710 and/or 720 may further include transceivers 716 and 726, respectively, configured to transmit and receive information. The transceivers 716 and 726 may also include a radio interface (for example, a modem) respectively coupled to the antennas 715 and 725. The radio interface may correspond to a plurality of radio access technologies including one or more of GSM, LTE, LTE-A, 5G, NR, WLAN, NB-IoT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 716 and 726 may be respectively configured to modulate information on to a carrier waveform for transmission by the antenna(s) 715 and 725, and demodulate information received via the antenna(s) 715 and 725 for further processing by other elements of apparatuses 710 and/or 720. In other example embodiments, transceivers 716 and 726 may be capable of transmitting and receiving signals or data directly. Additionally or alternatively, in some example embodiments, apparatuses 710 and/or 720 may include an input and/or output device (I/O device). In certain example embodiments, apparatuses 710 and/or 720 may further include a user interface, such as a graphical user interface or touchscreen.

In certain example embodiments, memory 712 and memory 722 store software modules that provide functionality when executed by processors 711 and 721, respectively. The modules may include, for example, an operating system that provides operating system functionality for apparatuses 710 and/or 720. The memory may also store one or more functional modules, such as an application or program, to provide additional functionality for apparatuses 710 and/or 720. The components of apparatuses 710 and/or 720 may be implemented in hardware, or as any suitable combination of hardware and software. According to certain example embodiments, apparatus 710 may optionally be configured to communicate with apparatus 720 via a wireless or wired communications link 730 according to any radio access technology, such as NR.

According to certain example embodiments, processors 711 and 721, and memory 712 and 722 may be included in or may form a part of processing circuitry or control circuitry. In addition, in some example embodiments, transceivers 716 and 726 may be included in or may form a part of transceiving circuitry.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 710 and/or 720) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 710 and/or 720), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3rd Generation Partnership Project
5G 5th Generation
5GCN 5G Core Network
5GS 5G System
BWP Bandwidth Part
CLI Cross-Link Interference
CP-OFDM Cyclic prefix OFDM
CSI-RS Channel State Information Reference Signal
DCI Downlink Control Information
DFT-s Discrete Fourier Transform Spread
DL Downlink
DMRS Demodulation Reference Signal
EMBB Enhanced Mobile Broadband
FDSS Frequency Domain Spectrum Shaping
FFT Fast Fourier Transform
gNB 5G or Next Generation NodeB
LTE Long Term Evolution
MPR Maximum Power Reduction
NR New Radio
NW Network Node
OFDM Orthogonal Frequency Division Multiplexing
PAPR Peak-To-Average Power Ratio
PDSCH Physical Downlink Shared Channel
PRACH Physical Random-Access Channel
PRB Physical Resource Block
PUSCH Physical Uplink Shared Channel
RedCap Reduced capability NR
RRC Radio Resource Control
SBFD Subband Full Duplex
SL Sidelink
UE User Equipment
UL Uplink
URLLC Ultra Reliable Low Latency Communication

1-66. (canceled)

67. An apparatus, comprising:
at least one processor; and
at least one memory storing instructions that, when executed by the at least one processor, cause the apparatus at least to:
receive, from a network entity, information on slots and symbols of a transmission to be scheduled comprising a signal to be transmitted on a physical channel, the signal comprising at least one reference signal, the information on the slots and the symbols comprising at least a type of slot and symbol for unidirectional transmissions and a type of slot and symbol for bidirectional transmissions;
receive a first configuration and a second configuration of time domain resource allocation information of the signal and a waveform of the transmission to be scheduled, the first configuration and the second configuration having different densities of symbols of the signal in the transmission to be scheduled or having different waveforms of the transmission to be scheduled relative to each other; and
determine time domain resource allocation of the signal and the waveform of the transmission to be scheduled, based on at least the information on the slots and the symbols and at least one of the first configuration and the second configuration.

68. The apparatus according to claim 67, wherein the slots and the symbols are at least one of sub-band full duplex or non-sub-band full duplex.

69. The apparatus according to claim 67, wherein the time domain resource allocation of the signal and the waveform of the transmission to be scheduled are determined based on the first configuration when the slots and the symbols are sub-band full duplex.

70. The apparatus according to claim 67, wherein:
the time domain resource allocation of the signal and the waveform of the transmission to be scheduled are determined based on the first configuration when the slots and the symbols are non-sub-band full duplex; and
the time domain resource allocation of the signal and the waveform of the transmission to be scheduled are determined based on the second configuration when the slots and the symbols are sub-band full duplex.

71. The apparatus according to claim 70, wherein the time domain resource allocation of the signal and the waveform of the transmission to be scheduled are determined based on both the first configuration and the second configuration when the slots and the symbols comprise sub-band full duplex and non-sub-band full duplex.

72. The apparatus according to claim 67, wherein the at least one memory stores instructions that, when executed by the at least one processor, further causes the apparatus at least to:
receive, from the network entity, a scheduled transmission based on the determined time domain resource allocation of the signal and the waveform of the transmission to be scheduled.

73. The apparatus according to claim 67, wherein the at least one memory stores instructions that, when executed by the at least one processor, further causes the apparatus at least to:
provide, to the network entity, a scheduled transmission based on the determined time domain resource allocation of this signal and the waveform of the transmission to be scheduled.

74. The apparatus according to claim 67, wherein the signal is a demodulation reference signal.

75. The apparatus according to claim 74, wherein:
the demodulation reference signal comprises one of either a first demodulation reference signal when the slots and the symbols are sub-band full duplex, and a second demodulation reference signal when the slots and the symbols are non-sub-band full duplex; and
the first demodulation reference signal is different than the second demodulation reference signal.

76. The apparatus according to claim 67, wherein the first configuration and the second configuration have different densities of symbols of the signal in the transmission to be scheduled and have different waveforms of the transmission to be scheduled relative to each other.

77. An apparatus, comprising:
at least one processor; and
at least one memory storing instructions that, when executed by the at least one processor, cause the apparatus at least to:
provide, to a user equipment, information on slots and symbols of a transmission to be scheduled comprising a signal to be transmitted on a physical channel, and at least one of a first configuration and a second configuration for determining time domain resource allocation of the signal and a waveform of the transmission to be scheduled, the signal comprising at least one reference signal, the first configuration and the second configuration having different densities of symbols of the signal in the transmission to be scheduled or having different waveforms of the transmission to be scheduled relative to each other, and the information on the slots and the symbols comprises at least a type of slot and symbol for unidirectional transmissions and a type of slot and symbol for bidirectional transmissions;
schedule a transmission in slots and symbols associated with the signal and at least one of the first configuration and the second configuration; and
provide, to the user equipment, the scheduling of the transmission in slots and symbols.

78. The apparatus according to claim 77, wherein the slots and the symbols are at least one of sub-band full duplex or non-sub-band full duplex.

79. The apparatus according to claim 77, wherein the time domain resource allocation of the signal and the waveform of the transmission to be scheduled are determined based on the first configuration when the slots and the symbols are sub-band full duplex.

80. The apparatus according to claim 77, wherein:
the scheduling of the transmission is provided based on the first configuration when the slots and the symbols are non-sub-band full duplex; and
the scheduling of the transmission is provided based on the second configuration when the slots and the symbols are sub-band full duplex.

81. The apparatus according to claim 80, wherein the scheduling of the transmission is provided based on both the first configuration and the second configuration when the slots and the symbols comprise sub-band full duplex and non-sub-band full duplex.

82. The apparatus according to claim 77, wherein the at least one memory stores instructions that, when executed by the at least one processor, further causes the apparatus at least to:
provide, to the user equipment, a scheduled transmission based on the time domain resource allocation of the signal and the waveform of the transmission to be scheduled.

83. The apparatus according to claim 77, wherein the at least one memory stores instructions that, when executed by the at least one processor, further causes the apparatus at least to:
receive, from the user equipment, a scheduled transmission based on the time domain resource allocation of the signal and the waveform of the transmission to be scheduled.

84. The apparatus according to claim 77, wherein the first configuration and the second configuration have different densities of symbols of the signal in the transmission to be scheduled and have different waveforms of the transmission to be scheduled relative to each other.

85. A method, comprising:
receiving, by an apparatus from a network entity, information on slots and symbols of a transmission to be scheduled comprising a signal to be transmitted on a physical channel, the signal comprising at least one reference signal, the information on the slots and the symbols comprising at least a type of slot and symbol for unidirectional transmissions and a type of slot and symbol for bidirectional transmissions;
receiving, by the apparatus, a first configuration and a second configuration of time domain resource allocation information of the signal and a waveform of the transmission to be scheduled, the first configuration and the second configuration having different densities of symbols of the signal in the transmission to be scheduled or having different waveforms of the transmission to be scheduled relative to each other; and
determining, by the apparatus, time domain resource allocation of the signal and the waveform of the transmission to be scheduled, based on at least the information on the slots and the symbols and at least one of the first configuration and the second configuration.

86. The method according to claim 85, wherein the slots and the symbols are at least one of sub-band full duplex or non-sub-band full duplex.
